(19) United States
(12) Patent Application Publication
(10) Pub. No.: US 2019/0373938 A1
(43) Pub. Date: Dec. 12, 2019

(54) Preparation of Recombinant Rice with Low Glycemic Index from a Raw Material of Resistant Starch

(71) Applicant: Jiangnan University, Wuxi (CN)

(72) Inventors: Yaoqi TIAN, Wuxi (CN); Canxin CAI, Wuxi (CN); Bihua ZHU, Wuxi (CN); Jinling ZHAN, Wuxi (CN); Zhengyu JIN, Wuxi (CN)

(21) Appl. No.: 16/550,388

(22) Filed: Aug. 26, 2019

Related U.S. Application Data
(63) Continuation of application No. PCT/CN2018/106891, filed on Sep. 21, 2018.

(30) Foreign Application Priority Data
Jul. 19, 2018 (CN) 201810794389X

(51) Int. Cl. A23L 33/21; C08B 31/04; A23L 29/219; A23L 29/256; A23L 29/269; A23L 7/10; A23P 30/25

(52) U.S. Cl. CPC A23L 33/21; C08B 31/04; A23L 29/219; A23V 2002/00; A23L 29/27; A23L 7/198; A23P 30/25; A23L 29/256

(57) ABSTRACT

The present disclosure disclosed is a preparation method for low glycemic index resistance starch recombinant rice, which belongs to the technical field of food. The method of the present disclosure is as follows: after starch and lipid in an alcohol aqueous system are complexed under low temperature, variable-temperature crystallization is performed, so that a low glycemic index resistance starch is prepared, and then, with the low glycemic index resistance starch as a main material, low glycemic index recombinant rice is prepared by the extrusion technique. The low glycemic index resistance starch prepared by utilizing the method of the present disclosure has the functions of controlling postprandial blood glucose, protecting and transporting fatty acid, retarding starch retrogradation and so on. The low glycemic index recombinant rice prepared by utilizing the method of the present disclosure is suitable for being eaten by patients with type II diabetes.

### TECHNICAL FIELD

The disclosure herein relates to the technical field of food, relating to preparation of recombinant rice with low glycemic index from a raw material of resistant starch.

### BACKGROUND

In recent ten years, the number of diabetics around the world has been rapidly increasing at an alarming rate. According to statistics in 2010, the total number of diabetics in China has reached one hundred sixteen millions, accounting for 11.6% of the total population. China has become a country with the largest population of diabetics in the world, so the prevention and treatment of diabetes have become one of the main public health issues in China as well.

Postprandial hyperglycemia is a main factor leading to diabetes, aggravation of diabetes and diabetic complications, while the main “culprit” of postprandial hyperglycemia is staples (i.e. carbohydrate). Therefore, the selection and control of staples (i.e. carbohydrate) are the basis of diabetes treatment, and concern the long-term control of blood glucose in diabetics and the occurrence and development of chronic complications, so choosing low-glycemic index staples is the key point of dietary therapy for diabetes.

Starch is the most important carbohydrate source for the human being, playing an irreplaceable role in the daily life of people. Nowadays, there have been a lot of studies which prove that with a low glycemic index (GI), slowly digestible starch plays an important role in controlling the levels of postprandial blood glucose and insulin, improving insulin resistance, decreasing the pressure of the blood glucose homeostasis control system and preventing and treating various diet-related chronic diseases.

At present, main preparation methods for slowly digestible resistant starch include physical methods, chemical modification methods, biological enzyme methods, the combination of a variety of methods, etc., but defects, such as complex preparation methods, poor product effect, easy production of harmful substances in the process of preparation, etc., still exist in the conventional methods.

Therefore, it is highly desirable to develop a new method that is low in cost, can easily realize mass industrial production, and can overcome the processing instability of resistant starch products themselves.

### SUMMARY

The present disclosure provides a preparation method for low glycemic index resistance starch recombinant rice. In the method, after starch and lipid in an alcohol aqueous system are complexed under low temperature, variable-temperature crystallization is performed, so that a low glycemic index resistance starch is prepared, and then, with the low glycemic index resistance starch as a main material, low glycemic index recombinant rice is prepared by the extrusion technique. The low glycemic index resistance starch prepared by the method has the functions of controlling postprandial blood glucose, protecting and transporting fatty acid, retarding starch retrogradation and so on. The prepared low glycemic index recombinant rice is suitable for being eaten by patients with type II diabetes. The method has the advantages of increasing the added value of agricultural and sideline products, reducing the production cost of convenient rice, increasing the production efficiency of convenient rice, etc.

The technical solution of the present disclosure is as follows:

The present disclosure provides a preparation method for low glycemic index resistance starch. The method is as follows: rice starch is dispersed into an ethanol solution A, so that a starch solution is obtained; the temperature of the starch solution is kept under 35° C. to 50° C. for the first time and the starch solution is added with an NaOH solution to conduct reaction for the first time, so that a reaction mixture A is obtained; fatty acid is dissolved in an ethanol solution B, so that a fatty acid solution is obtained; after being preheated under 45° C. to 55° C., the fatty acid solution is added into the reaction mixture A to conduct reaction for the second time, so that a reaction mixture B is obtained; after the pH of the reaction mixture B is regulated to become neutral, the reaction mixture B is cooled, so that a cooled reaction mixture B is obtained; and after the temperature of the cooled reaction mixture B is kept under 20° C. to 30° C. for the second time, post-processing is conducted, so that the low glycemic index starch-lipid complexed resistance starch is obtained.

In one embodiment of the present disclosure, the volume percentage concentration of the ethanol solution A is 50% to 60%.

In one embodiment of the present disclosure, the volume percentage concentration of the ethanol solution A is 55%.

In one embodiment of the present disclosure, the mass volume concentration of the starch solution is 15% to 25%.

In one embodiment of the present disclosure, the mass volume concentration of the starch solution is 20%.

In one embodiment of the present disclosure, keeping temperature for the first time means that the temperature of the starch solution is kept in a 35-50° C. thermostatic water bath oscillator.

In one embodiment of the present disclosure, keeping temperature for the first time means that the temperature of the starch solution is kept in a 45° C. thermostatic water bath oscillator.

In one embodiment of the present disclosure, the speed of adding the NaOH solution is 1 mL/min to 3 mL/min.

In one embodiment of the present disclosure, the speed of adding the NaOH solution is 2 mL/min.

In one embodiment of the present disclosure, the concentration of the NaOH solution is 0.5 mol/L to 1.5 mol/L.

In one embodiment of the present disclosure, the concentration of the NaOH solution is 1.0 mol/L.

In one embodiment of the present disclosure, the time of the first reaction is 20 to 30 minutes.

In one embodiment of the present disclosure, the time of the first reaction is 25 minutes.

In one embodiment of the present disclosure, the ratio of starch mass to NaOH mass to ethanol volume in the reaction mixture A is 1.0 g:(0.3-0.5) g:(2.4-3.3) mL.

In one embodiment of the present disclosure, the ratio of starch mass to NaOH mass to ethanol volume in the reaction mixture A is 1.0 g:0.4 g:3.0 mL.

In one embodiment of the present disclosure, the mass of the fatty acid is 5% to 15% of the mass of the rice starch.

In one embodiment of the present disclosure, the mass of the fatty acid is 8% of the mass of the rice starch.

In one embodiment of the present disclosure, the volume percentage concentration of the ethanol solution B is 60% to 70%.

In one embodiment of the present disclosure, the volume percentage concentration of the ethanol solution B is 65%.

In one embodiment of the present disclosure, the ratio of starch mass to fatty acid mass to NaOH mass to ethanol volume in the reaction mixture B is 1.0 g:(0.05-0.15) g:(0.3-0.5) g:(2.0-3.6) mL.

In one embodiment of the present disclosure, the ratio of starch mass to fatty acid mass to NaOH mass to ethanol volume in the reaction mixture B is 1.0 g:0.1 g:0.4 g:3.0 mL.

In one embodiment of the present disclosure, the preheating means that the fatty acid solution is preheated in a 45-55° C. thermostatic water bath.

In one embodiment of the present disclosure, the preheating means that the fatty acid solution is preheated in a 50° C. thermostatic water bath.

In one embodiment of the present disclosure, the time of the preheating is 3 to 10 minutes.

In one embodiment of the present disclosure, the time of the preheating is 5 minutes.

In one embodiment of the present disclosure, the fatty acid is oleic acid, linoleic acid and α-linolenic acid.

In one embodiment of the present disclosure, the fatty acid is linoleic acid.

In one embodiment of the present disclosure, the speed of adding the fatty acid solution into the reaction mixture A is 0.2 mL/min to 0.5 mL/min.

In one embodiment of the present disclosure, the speed of adding the fatty acid solution into the reaction mixture A is 0.4 mL/min.

In one embodiment of the present disclosure, the time of the second reaction is 45 to 90 minutes.

In one embodiment of the present disclosure, the time of the second reaction is 60 minutes.

In one embodiment of the present disclosure, regulating the pH of the reaction mixture B to become neutral means that an HCl solution is added into the reaction mixture B to regulate pH to become neutral.

In one embodiment of the present disclosure, the concentration of the HCl solution is 0.5 mol/L to 1.5 mol/L.

In one embodiment of the present disclosure, the concentration of the HCl solution is 1.0 mol/L.

In one embodiment of the present disclosure, the cooling means that the reaction mixture B is immediately transferred into a −20-4° C. environment and quickly cooled.

In one embodiment of the present disclosure, the cooling means that the reaction mixture B is immediately transferred into a 4° C. environment and quickly cooled.

In one embodiment of the present disclosure, the time of the cooling is 3 to 5 minutes.

In one embodiment of the present disclosure, the time of the cooling is 5 minutes.

In one embodiment of the present disclosure, keeping temperature for the second time means that the temperature of the cooled reaction mixture B is kept in a 20-30° C. water bath.

In one embodiment of the present disclosure, keeping temperature for the second time means that the temperature of the cooled reaction mixture B is kept in a 25° C. water bath.

In one embodiment of the present disclosure, the time taken to keep temperature for the second time is 0.5 to 1 hour.

In one embodiment of the present disclosure, the time taken to keep temperature for the second time is 1 hour.

In one embodiment of the present disclosure, the post-processing is as follows: after temperature is kept for the second time, the reaction mixture B is centrifuged, and after supernate is removed, a crude resistant starch product is obtained; and the crude resistant starch product is washed with water, dried and ground, so that a starch-lipid complexed resistant starch with a low glycemic index is obtained.

In one embodiment of the present disclosure, the speed of the centrifuging is 8000 g to 10000 g.

In one embodiment of the present disclosure, the speed of the centrifuging is 10000 g.

In one embodiment of the present disclosure, the time of the centrifuging is 3 to 10 minutes.

In one embodiment of the present disclosure, the time of the centrifuging is 5 minutes.

In one embodiment of the present disclosure, the water is distilled water.

In one embodiment of the present disclosure, the washing is performed three times.

In one embodiment of the present disclosure, the drying is blast drying or countercurrent bed drying.

In one embodiment of the present disclosure, the temperature of the drying is 40° C., and the time of the drying is 24 hours.

In one embodiment of the present disclosure, the grinding means that the crude resistant starch product is ground until it can pass through a 100-mesh sieve.

The present disclosure provides a low glycemic index resistance starch prepared by applying the preparation method for low glycemic index resistance starch.

The present disclosure provides application of a preparation method for the low glycemic index resistance starch or the prepared low glycemic index resistance starch in the preparation of food, drugs and health-care products.

The present disclosure provides a preparation method for low glycemic index recombinant rice, and the method uses the prepared low glycemic index resistance starch.

In one embodiment of the present disclosure, the method is as follows: rice flour, the prepared low glycemic index resistance starch, soybean polysaccharide, propylene glycol alginate, sodium alginate and xanthan gum are mixed, so that extruded material powder is obtained; the extruded material powder is added with water and blended, so that extruded material slurry is obtained; the extruded material slurry is sent into an extruder, extrusion granulation is performed while temperature is controlled, and thereby the low glycemic index recombinant rice is obtained.

In one embodiment of the present disclosure, the mass ratio of the rice flour to the prepared low glycemic index resistance starch to the soybean polysaccharide to the propylene glycol alginate to the sodium alginate to the xanthan gum is (50-70):(35-50):(0.25-0.75):(0.1-0.2):(0.1-0.2):(0.2-0.4).

In one embodiment of the present disclosure, the mass ratio of the rice flour to the prepared low glycemic index resistance starch to the soybean polysaccharide to the propylene glycol alginate to the sodium alginate to the xanthan gum is 60:40:0.5:0.15:0.15:0.3.

In one embodiment of the present disclosure, the rice flour is rice flour capable of passing through a 80-to-100-mesh sieve.

In one embodiment of the present disclosure, the rice flour is rice flour capable of passing through a 100-mesh sieve.

In one embodiment of the present disclosure, the soybean polysaccharide is soluble soybean polysaccharide.

In one embodiment of the present disclosure, the amount of the added water is 30 to 40 percent of the total mass of the extrusion material flour.

In one embodiment of the present disclosure, the amount of the added water is 35 percent of the total mass of the extrusion material flour.

In one embodiment of the present disclosure, the water is distilled water.

In one embodiment of the present disclosure, the extruder is a twin-screw extruder.

In one embodiment of the present disclosure, the feeding speed of sending the extrusion material into the twin-screw extruder is 2 kg/h to 5 kg/h before extrusion is started.

In one embodiment of the present disclosure, the feeding speed of sending the extrusion material into the twin-screw extruder is 3 kg/h before extrusion is started.

In one embodiment of the present disclosure, the rotational speed of the screws of the twin-screw extruder is 90 rpm to 130 rpm.

In one embodiment of the present disclosure, the rotational speed of the screws of the twin-screw extruder is 110 rpm.

In one embodiment of the present disclosure, the die aperture of the discharge hole of the twin-screw extruder is 4 mm to 8 mm.

In one embodiment of the present disclosure, the die aperture of the discharge hole of the twin-screw extruder is 4 mm.

In one embodiment of the present disclosure, the rotational speed of a cutting machine at the discharge hole of the twin-screw extruder is 200 rpm to 250 rpm.

In one embodiment of the present disclosure, the rotational speed of the cutting machine at the discharge hole of the twin-screw extruder is 250 rpm.

In one embodiment of the present disclosure, controlling temperature means that the four temperatures of the twin-screw extruder are respectively set as 55-70° C., 70-85° C., 85-100° C. and 100-120° C.

In one embodiment of the present disclosure, controlling temperature means that the four temperatures of the twin-screw extruder are respectively set as 60° C., 80° C., 90° C. and 110° C.

In one embodiment of the present disclosure, the grain size of the low glycemic index recombinant rice is 4 mm to 6 mm.

In one embodiment of the present disclosure, the grain size of the low glycemic index recombinant rice is 5 mm.

In one embodiment of the present disclosure, the method further comprises drying the obtained low glycemic index recombinant rice.

In one embodiment of the present disclosure, the drying means that a hot-air fluidized bed is adopted to dry the obtained low glycemic index recombinant rice.

In one embodiment of the present disclosure, the temperature of the drying is 100° C. to 130° C.

In one embodiment of the present disclosure, the temperature of the drying is 110° C.

In one embodiment of the present disclosure, the time of the drying is 10 to 15 minutes.

In one embodiment of the present disclosure, the time of the drying is 12 minutes.

In one embodiment of the present disclosure, the drying means that the obtained low glycemic index recombinant rice is dried until the content of moisture is 6% to 10%.

In one embodiment of the present disclosure, the drying means that the obtained low glycemic index recombinant rice is dried until the content of moisture is 8%.

In one embodiment of the present disclosure, the method further comprises cooling and packaging.

The present disclosure provides a low glycemic index recombinant rice prepared by applying the preparation method for low glycemic index recombinant rice.

The present disclosure provides application of a preparation method for the low glycemic index recombinant rice or the prepared low glycemic index recombinant rice in the preparation of food, drugs and health-care products.

Beneficial Effects:

(1) By conducting variable-temperature crystallization after starch and lipid in an alcohol aqueous system are complexed, the present disclosure prepares a low glycemic index resistance starch, and in the low glycemic index resistance starch, the content of resistant starch accounts for 50% to 65% or more of the total starch content of the starch-lipid complexed resistant starch product and the glycemic index of the low glycemic index resistance starch is 35 to 40 or less.

(2) As the present disclosure adopts rice starch as a raw material to prepare the low glycemic index resistance starch, belonging to amylose with a hydrophobic spiral cavity, the rice starch can hydrophobically interact with lipid and other compounds to form a V-type unispiral crystalline structure, and having certain thermodynamic stability and enzymolysis resistance, the crystalline structure is digested more slowly than ordinary starch in the body, enabling the low glycemic index resistance starch prepared by the present disclosure to have a digestion-resistant property.

(3) In the process of preparing the low glycemic index resistance starch, the present disclosure controls the reaction system, complexing starch and lipid under low temperature, so that the low glycemic index resistance starch prepared by the present disclosure has the functions of protecting unsaturated fatty acid, retarding starch retrogradation, increasing the stability of the starch-based structure and so on (in the prior art, a starch-lipid complex is prepared mainly by the solvent method, the gelatinization method, the high-pressure treatment method, the cooking method, the extrusion method or other methods, and all these reactions need to be conducted under high temperature, which can easily decrease the stability of unsaturated fatty acid).

(4) With the low glycemic index resistance starch as a raw material, the present disclosure prepares the low glycemic index recombinant rice suitable for being eaten by patients with type II diabetes by means of the extrusion forming technique, and the glycemic index of the recombinant rice is 50 to 55 or less.

(5) The method of the present disclosure has the advantages of short production period, high production efficiency and low cost, and can easily realize mass industrial production.

### DETAILED DESCRIPTION

An assay method involved in the following examples is as follows:

Determination of resistant starch content (adopting the Englyst method):

200 mg of sample is weighed and put into a 50 mL centrifuge tube, 2 mL of water is added, and after uniform blending, the blend is put into a 37° C. thermostatic water bath and oscillated (rotational speed: 160 rpm); the blend is added with 4 mL of pepsin solution (containing 0.5 g of pepsin and 0.5 g of guar gum dispersed in 100 mL of 5 mol/L hydrochloric acid solution) to react for 30 minutes, five glass beads and 2 mL of 0.5 mol/L sodium acetate solution (pH=5.2) are then added into each testing centrifuge tube, and oscillation is continued for 30 minutes; 2 mL of mixed enzyme solution (8 g of pancreatin and 1.96 mL of glucoamylase (260 U/mL) dispersed in 44.8 mL of water) is then added, and after 120 minutes of hydrolysis, 0.1 mL of sample is extracted and added into 0.9 mL of 90% ethanol to inactivate enzyme; after 5 minutes of centrifuging at 10000 g, supernate is extracted, a glucose oxidase kit (GOD-POD) is adopted to determine the content of glucose with water without sample as a blank sample, parallel determination is conducted for each sample three times, and a mean value is obtained.

Resistant starch (RS) is starch which cannot be digested and absorbed by the small intestine within 120 minutes, and the specific formula is as follows:

RS %=(TG−G₁₂₀)×0.9×100%/TS

In the formula, G₁₂₀ is glucose/mg released after 120 minutes of enzymolysis, TG is total glucose/mg in the sample, and TS is the dry basis mass/mg of total starch in the sample.

Determination of in-vitro simulated glycemic index (adopting the Goni method):

200 mg of sample is weighed and put into a 50 mL centrifuge tube, 2 mL of water is added, and after uniform blending, the blend is put into a 37° C. thermostatic water bath and oscillated (rotational speed: 160 rpm); the blend is added with 4 mL of pepsin solution (containing 0.5 g of pepsin and 0.5 g of guar gum dispersed in 100 mL of 5 mol/L hydrochloric acid) to react for 30 minutes, five glass beads and 2 mL of 0.5 mol/L sodium acetate solution (pH=5.2) are then added into each testing centrifuge tube, and oscillation is continued for 30 minutes; 2 mL of mixed enzyme solution (8 g of pancreatin and 1.96 mL of glucoamylase (260 U/mL) dispersed in 44.8 mL of water) is then added, and time is accurately counted; after 0, 30, 60, 90, 120 and 180 minutes of oscillation for hydrolysis, 0.1 mL of sample is extracted and added into 0.9 mL of 90% ethanol to inactivate enzyme; after 5 minutes of centrifuging at 10000 g, supernate is extracted, a glucose oxidase kit (GOD-POD) is adopted to determine the content of glucose with water without sample as a blank sample, parallel determination is conducted for each sample three times, and a mean value is obtained; the digestion rate of the sample is marked with the hydrolysis rate (%) of the sample within 0 to 180 minutes, and a graph is drawn to calculate the area under the curve (AUC) of hydrolysis.

A calculation formula for the hydrolysis index (HI) and glycemic index of a sample is as follows:

$$HI = \frac{AUC ( sample )}{AUC ( reference )} \times 100 \% GI = 0.549 \times HI + 37.91$$

### EXAMPLE 1

### Preparation of Low Glycemic Index Resistance Starch

Specific steps are as follows:

(1) Each raw material is obtained according to the formula of table 1;

(2) the rice starch is weighed and dispersed into a 55% (v/v) ethanol solution A, so that a 20% (w/v) starch solution is prepared, the temperature of the starch solution is kept in a 45° C. thermostatic water bath oscillator, meanwhile, a 1.0 mol/L NaOH solution is added at a rate of 2 mL/min, and reaction is sufficiently conducted for 25 minutes;

(3) the fatty acid is dissolved in a 65% (v/v) ethanol solution B until the ratio of starch mass to NaOH mass to ethanol solution A volume to fatty acid mass to ethanol solution B volume in the reaction mixture is shown as table 1, subsequently the solution is preheated in a 50° C. thermostatic water bath for 5 minutes and then added into the starch solution system at a rate of 0.4 mL/min, reaction is sufficiently conducted for 75 minutes, and a 1.0 mol/L HCl solution is then added to regulate pH to become neutral;

(4) after the reaction is complete, the starch-lipid complex is immediately transferred into a −20° C. environment and quickly cooled for 3 minutes, and the temperature of the starch-lipid complex is then kept in a 25° C. water bath for 1 hour;

(5) after temperature keeping is complete, centrifuging is performed at 10000 g for 5 minutes, and after supernate is removed, a crude product is obtained; and

(6) after being washed with distilled water three times, the crude product is dried in 40° C. blast for 24 hours and then ground until it can pass through a 100-mesh sieve, and thereby a starch-lipid complexed resistant starch product is obtained.

TABLE 1
Raw Material Formula

| | Rice | | Ethanol solution | Fatty | Ethanol solution |
|---|---|---|---|---|---|
| | starch/g | NaOH/g | A/mL | acid/g | B/mL |
| A | 1.0 | 0.4 | 3.0 | 0.1 | 3.0 |
| B | 1.0 | 0.1 | 3.0 | 0.1 | 3.0 |
| C | 1.0 | 0.8 | 3.0 | 0.1 | 3.0 |
| D | 1.0 | 0.5 | 2.4 | 0.15 | 2.0 |
| E | 1.0 | 0.4 | 5.0 | 0.1 | 5.0 |
| F | 1.0 | 0.4 | 3.0 | 0.02 | 3.0 |

Among them, the concentration of the ethanol solution A is 55% (v/v); and the concentration of the ethanol solution B is 65% (v/v).

The resistant starch content and glycemic index of the obtained low glycemic index resistance starch are assayed, and the assay result is shown in table 2.

TABLE 2
Resistant Starch Content and In-vitro Simulated
Glycemic Index Assay Result

| | Resistant starch content (%) | In-vitro simulated glycemic index |
|---|---|---|
| A | 66.2 ± 0.4 | 34.3 ± 0.3 |
| B | 42.7 ± 0.1 | 56.1 ± 0.5 |
| C | 39.4 ± 0.2 | 63.2 ± 0.1 |
| D | 52.7 ± 0.3 | 38.6 ± 0.2 |
| E | 48.6 ± 0.5 | 42.3 ± 0.4 |
| F | 35.8 ± 0.1 | 69.1 ± 0.2 |

It can be known from the result that all the factors including the NaOH, the ethanol solution A, the fatty acid and the ethanol solution B will affect the complexing effect of starch and lipid and the content of the resistant starch, so a product with high resistant starch content and low in-vitro simulated glycemic index needs to be prepared within the ratio defined by the present disclosure.

### EXAMPLE 2

### Preparation of Low Glycemic Index Resistance Starch

Specific steps are as follows:

(1) the rice starch is weighed and dispersed into a 55% (v/v) ethanol solution A, so that a 20% (w/v) starch solution is prepared, the temperature of the starch solution is kept in a 45° C. thermostatic water bath oscillator, meanwhile, a 1.0 mol/L NaOH solution is added at a rate of 2 mL/min until the ratio of starch mass to NaOH mass to ethanol volume in the reaction mixture A is 1.0:0.4:3.0, and reaction is sufficiently conducted for 25 minutes;

(2) the fatty acid is dissolved in a 65% (v/v) ethanol solution B until the ratio of starch mass to fatty acid mass to NaOH mass to ethanol volume in the reaction mixture B is 1.0 g:0.1 g:0.4 g:3.0 mL, the solution is preheated in a 50° C. thermostatic water bath for 5 minutes and then added into the starch solution system at a rate of 0.4 mL/min, reaction is sufficiently conducted for 75 minutes, and a 1.0 mol/L of HCl solution is then added to regulate pH to become neutral;

(3) the specific operation conditions of low-temperature complexing and cooling crystallization are adjusted according to table 3;

(4) after temperature keeping is complete, centrifuging is performed at 10000 g for 5 minutes, and after supernate is removed, a crude product is obtained; and

(5) after being washed with distilled water three times, the crude product is dried in 40° C. blast for 24 hours and then ground until it can pass through a 100-mesh sieve, and thereby a starch-lipid complexed resistant starch product is obtained.

TABLE 3
Operation Conditions of Low-temperature Complexing
and Variable-temperature Crystallization Techniques

| | | | | | Water bath |
|---|---|---|---|---|---|
| | | Quick cooling | Quick | bath | temperature |
| | Reaction | temperature/ | cooling | temperature/ | keeping |
| | time/min | ° C. | time/min | ° C. | time/min |
| A | 60 | 4 | 5 | 25 | 60 |
| B | 45 | 4 | 3 | 25 | 30 |
| C | 60 | −80 | 5 | 25 | 60 |
| D | 60 | 4 | 3 | 25 | 30 |
| E | 60 | −20 | 5 | 20 | 60 |
| F | 60 | −20 | 2 | 10 | 15 |

Among them, the ratio of the starch to the fatty acid to the NaOH to the ethanol in the reaction mixture B is 1.0:0.1:0.4:3.0 (m:m:m:V).

The resistant starch content and glycemic index of the obtained low glycemic index resistance starch are assayed, and the assay result is shown in table 4.

TABLE 4
Resistant Starch Content and In-vitro Simulated
Glycemic Index Assay Result

| | Resistant starch content | In-vitro simulated glycemic |
|---|---|---|
| | (%) | index |
| A | 67.4 ± 0.2 | 33.8 ± 0.1 |
| B | 53.7 ± 0.1 | 38.4 ± 0.5 |
| C | 37.2 ± 0.3 | 57.1 ± 0.2 |
| D | 55.9 ± 0.4 | 39.5 ± 0.3 |
| E | 60.1 ± 0.1 | 35.7 ± 0.2 |
| F | 46.3 ± 0.2 | 43.9 ± 0.4 |

It can be known from the result that all the factors including starch and lipid complexing time, quick cooling temperature and time in the variable-temperature crystallization technique, water bath temperature and temperature keeping time will affect the complexing effect of starch and lipid and the content of the resistant starch, so a product with high resistant starch content and low in-vitro simulated glycemic index needs to be prepared within the conditions defined by the present disclosure.

### EXAMPLE 3

### Preparation of Low Glycemic Index Recombinant Rice

Specific steps are as follows:

(1) Each raw material is obtained according to the formula of table 5 (here, low glycemic index resistance starch is the low glycemic index resistance starch obtained according to the group A in example 2);

(2) the raw materials are uniformly mixed by using a stirrer and then added with distilled water which is 35% of the mass of the materials, water is added for conditioning, and after uniform mixing is performed again, a mixture is obtained;

(3) after conditioning is complete, the mixture is sent into a twin-screw extruder, the solid feeding speed is 3 kg/h before extrusion is started, the four temperatures of the twin-screw extruder are respectively set as 60° C., 80° C., 90° C. and 100° C., the rotational speed of the screws is 110 rpm, the die aperture of the discharge hole of the extruder is 6 mm, and the rotational speed of a cutting machine at the discharge hole is 250 rpm;

(4) extrusion granulation is performed by the twin-screw extruder, a cutter is used for cutting at the die, and thereby grainy granules or spherical or rod-like granules with a grain size of 4 mm in length are obtained;

(5) finally, the prepared rice granule product is dried by adopting a hot-air fluidized bed, drying temperature is 110° C., drying time is 12 minutes, and moisture is controlled at 8% after drying; and

(6) after drying, the rice granule product is then cooled and packaged, and thereby low glycemic index recombinant rice is obtained.

TABLE 5
Raw Material Formula

| | | Low | | | | |
|---|---|---|---|---|---|---|
| | | glycemic | | | | |
| | | index | | Propylene | | |
| | Rice | resistance | Soybean | glycol | Sodium | Xanthan |
| | flour | starch | polysaccharide | alginate | alginate | gum |
| A | 60 | 40 | 0.5 | 0.15 | 0.15 | 0.3 |
| B | 70 | 35 | 0.5 | 0.15 | 0.15 | 0.3 |
| C | 50 | 50 | 0.5 | 0.15 | 0.15 | 0.3 |
| D | 80 | 20 | 0.5 | 0.15 | 0.15 | 0.3 |
| E | 60 | 40 | 0.25 | 0.1 | 0.1 | 0.2 |
| F | 60 | 40 | 0.75 | 0.2 | 0.2 | 0.4 |

Among them, the rice flour used is rice flour capable of passing through a 100-mesh sieve; the soybean polysaccharide used is soluble soybean polysaccharide; and the low glycemic index resistance starch used is the low glycemic index resistance starch prepared by adopting the conditions of the group A in example 1 and example 2.

The glycemic index of the obtained low glycemic index recombinant rice is assayed, and the assay result is shown in table 6.

TABLE 6
Glycemic Index Assay Result

| | Glycemic index |
|---|---|
| A | 48.3 ± 0.2 |
| B | 53.9 ± 0.4 |
| C | 42.6 ± 0.5 |
| D | 67.2 ± 0.3 |
| E | 50.4 ± 0.1 |
| F | 51.5 ± 0.2 |

It can be known from the result that the ratio of the rice flour to the low glycemic index resistance starch will affect the in-vitro simulated glycemic index of the recombinant convenient rice, and the low-glycemic index recombinant convenient rice needs to be prepared within the ratio defined by the present disclosure.

### EXAMPLE 4

### Preparation of Low Glycemic Index Recombinant Rice

Specific steps are as follows:

(1) According to the ratio of 60:40:0.5:0.15:0.15:0.3, rice flour, low-lycemic index resistant starch (here, the low-lycemic index resistant starch is the low-lycemic index resistant starch obtained according to the group A in example 2), soybean polysaccharide, propylene glycol alginate, sodium alginate and xanthan gum are weighed, so that raw materials are obtained;

(2) the raw materials are uniformly mixed by using a stirrer and then added with distilled water which is 35% of the mass of the materials, water is added for conditioning, and after uniform mixing is performed again, a mixture is obtained;

(3) after conditioning is complete, the mixture is sent into a twin-screw extruder, the solid feeding speed is 3 kg/h before extrusion is started, the four temperatures of the twin-screw extruder, the rotational speed of the screws and the die aperture of the discharge hole of the extruder are set according to operation conditions of the extrusion technique in table 7, and the rotational speed of a cutting machine at the discharge hole is set as 250 rpm;

(4) extrusion granulation is performed by the twin-screw extruder, a cutter is used for cutting at the die, and thereby spherical or rod-like granules are obtained;

(5) finally, the prepared rice granule product is dried by adopting a hot blast fluidized bed, drying temperature is 110° C., drying time is 12 minutes, and moisture is controlled at 8% after drying; and

(6) after drying, the rice granule product is then cooled and packaged, and thereby low glycemic index recombinant rice is obtained.

TABLE 7
Operation Conditions of Extrusion Technique

| | Screw | Screw | Screw | Screw | Rotational | Die |
|---|---|---|---|---|---|---|
| | temperature | temperature | temperature | temperature | speed of | aperture/m |
| | 1/° C. | 2/° C. | 3/° C. | 4/° C. | screws/rpm | m |
| A | 60 | 80 | 90 | 110 | 110 | 4 |
| B | 55 | 70 | 85 | 100 | 110 | 4 |
| C | 70 | 85 | 100 | 120 | 110 | 4 |
| D | 60 | 80 | 90 | 110 | 150 | 4 |
| E | 60 | 80 | 90 | 110 | 70 | 4 |
| F | 60 | 80 | 90 | 110 | 110 | 10 |

Among them, the mass ratio of the rice flour used to the prepared low glycemic index resistance starch to the soybean polysaccharide to the propylene glycol alginate to the sodium alginate to the xanthan gum is 60:40:0.5:0.15:0.15:0.3.

The resistant starch content and glycemic index of the obtained low glycemic index recombinant rice are assayed, and the assay result is shown in table 8.

TABLE 8
Glycemic Index Assay Result

| | Glycemic index |
|---|---|
| A | 47.6 ± 0.3 |
| B | 51.9 ± 0.1 |
| C | 53.3 ± 0.2 |
| D | 56.7 ± 0.4 |
| E | 57.9 ± 0.2 |
| F | 55.8 ± 0.1 |

It can be known from the result that all the factors including the four sections of screw temperatures, the rotational speed of the screws and the die aperture in the extrusion process will affect the in-vitro simulated glycemic index of the recombinant convenient rice, and the low-glycemic index recombinant convenient rice needs to be prepared within the conditions defined by the present disclosure.

Although the present disclosure has been disclosed as above with the preferred examples, the examples are not intended to limit the present disclosure. Any person skilled in the art can make various changes and embellishments without departing from the spirit and scope of the present disclosure, so the protection scope of the present disclosure shall be based on the definition of the claims.

What is claimed is:

1. A preparation method for low glycemic index resistance starch, comprising: dispersing rice starch into an ethanol solution A to obtain a starch solution; the starch solution being subjected to a first incubation under 35° C. to 50° C. and adding an NaOH solution to the starch solution for conducting a first reaction to obtain a reaction mixture A; dissolving fatty acid in an ethanol solution B to a fatty acid solution; preheating the fatty acid solution under 45° C. to 55° C., and then adding it into the reaction mixture A for conducting a second reaction to obtain a reaction mixture B; regulating a pH of the reaction mixture B to become neutral and then cooling the reaction mixture B to obtain a cooled reaction mixture B; and the cooled reaction mixture B being subjected to a second incubation under 20° C. to 30° C., and then conducting post-processing to obtain a low glycemic index starch-lipid complexed resistance starch.

2. The preparation method according to claim 1, wherein a volume percentage concentration of the ethanol solution A is 50% to 60%.

3. The preparation method according to claim 1, wherein a mass volume concentration of the starch solution is 15% to 25%.

4. The preparation method according to claim 1, wherein the first incubation is conducted in a 35-50° C. thermostatic water bath oscillator; and the time of the first reaction is 20 to 30 minutes.

5. The preparation method according to claim 1, wherein a speed of adding the NaOH solution is 1 mL/min to 3 mL/min; and a concentration of the NaOH solution is 0.5 mol/L to 1.5 mol/L.

6. The preparation method according to claim 1, wherein a ratio of starch mass to NaOH mass to ethanol volume in the reaction mixture A is 1.0 g:(0.3-0.5) g:(2.4-3.3) mL.

7. The preparation method according to claim 1, wherein mass of the fatty acid is 5% to 15% of mass of the rice starch.

8. The preparation method according to claim 1, wherein a volume percentage concentration of the ethanol solution B is 60% to 70%.

9. The preparation method according to claim 1, wherein a ratio of starch mass to fatty acid mass to NaOH mass to ethanol volume in the reaction mixture B is 1 g:(0.05-0.15) g:(0.3-0.5) g:(2:0-3.6) mL.

10. The preparation method according to claim 1, wherein the preheating is conducted in a 45-55° C. thermostatic water bath; and the time of the preheating is 3 to 10 minutes.

11. The preparation method according to claim 1, wherein a speed of adding the fatty acid solution into the reaction mixture A is 0.2 mL/min to 0.5 mL/min.

12. The preparation method according to claim 1, wherein the time of the second reaction is 45 to 90 minutes.

13. The preparation method according to claim 1, wherein the second incubation is conducted in a 20-30° C. water bath; and the time of the second incubation is 0.5 to 1 hour.

14. A low glycemic index resistance starch prepared by applying the preparation method for low glycemic index resistance starch according to claim 1.

15. A method for preparing food, drugs and health-care products, characterized by adopting the low glycemic index resistance starch according to claim 14 as a material.

16. A preparation method for low glycemic index recombinant rice by using the low glycemic index resistance starch according to claim 14.

17. The preparation method according to claim 16, comprising: mixing rice flour, the low glycemic index resistance starch, soybean polysaccharide, propylene glycol alginate, sodium alginate and xanthan gum to obtain extruded material powder; adding water to the extruded material powder and blending them to obtain extruded material slurry; sending the extruded material slurry into an extruder; and performing extrusion granulation while a temperature is controlled, thereby obtaining the low glycemic index convenient rice.

18. The preparation method according to claim 17, wherein a mass ratio of the rice flour to the low glycemic index resistance starch to the soybean polysaccharide to the propylene glycol alginate to the sodium alginate to the xanthan gum is (50-70):(35-50):(0.25-0.75):(0.1-0.2):(0.1-0.2):(0.2-0.4).

19. Low glycemic index recombinant rice prepared by using the preparation method according to claim 17.
